(19) United States
(12) Patent Application Publication
(10) Pub. No.: US 2020/0163817 A1
(43) Pub. Date: May 28, 2020

(54) AIR LOSS CUSHION FOR THERAPEUTIC SUPPORT SURFACE

(71) Applicant: INVACARE CORPORATION, Elyria, OH (US)

(72) Inventors: Julian VERKAAIK, Avon, OH (US); Robert BEKOSCKE, Medina, OH (US); Michael FADA, Elyria, OH (US)

(73) Assignee: INVACARE CORPORATION, Elyria, OH (US)

(21) Appl. No.: 16/612,894

(22) PCT Filed: May 11, 2018
(86) PCT No.: PCT/US2018/032280

§ 371 Date: Nov. 12, 2019

Related U.S. Application Data
(60) Provisional application No. 62/505,479, filed on May 12, 2017.

(51) Int. Cl. A61G 7/057; A61G 5/10

(52) U.S. Cl. CPC A61G 7/05776; A47C 27/083; A61G 7/05792; A61G 5/1045

(57) ABSTRACT

Systems and methods are provided for regulating pressure, temperature, and/or humidity at a support surface for a user of a wheelchair. Exemplary systems include an adaptable cushion system including at least one cushion having a plurality of pressurized zones, at least one sensor configured to determine pressure at a first pressurized zone, and a controller configured to control an air pump at the first pressurized zone. The air pump is configured to regulate pressure at the first pressurized zone.

### CROSS REFERENCE TO RELATED APPLICATIONS

This application claims the benefit of U.S. Provisional Patent Application No. 62/505,479, entitled “Air Loss Cushion for Therapeutic Support Surface” filed May 12, 2017, which is hereby incorporated by reference herein, in its entirety.

### TECHNICAL FIELD

The present disclosure generally relates to adaptable air loss cushions for therapeutic support surfaces for wheelchair users.

### BACKGROUND

It is well known that physically impaired individuals with such disabilities as general weakness, immobility, spinal cord injury, muscular dystrophy, multiple sclerosis, cerebral palsy, arthritis, etc. require the assistance of a wheelchair to be more mobile. Wheelchairs, which may be of the type manufactured by Invacare Corporation of Elyria, Ohio, for example, generally include user support surfaces for supporting a user while in the wheelchair. Support surfaces may also comprise a padded cushion for added comfort. For example, a seat mounted on the wheelchair forms a user support surface for the user to sit on. A seat back forms a user support surface for the user's back. A pair of arms and a pair of legs may be mounted on the wheelchair to form user support surfaces for the user's arms and legs, respectively.

Potential pressure points occur in areas where the user's body makes contact with the wheelchair support surfaces. These pressure points can result in pressure ulcers over time due to prolonged pressure without adequate pressure relief. Pressure points can also add to user discomfort due to excessive temperature or humidity.

It is therefore appreciated that a need exists for improved systems and methods directed at regulating pressure, temperature, and/or humidity at a support surface for a user of a wheelchair.

### SUMMARY

In an exemplary embodiment, an adaptable air loss cushion system is provided. The system includes at least one cushion having a first permeable surface and a plurality of pressurized zones, at least one sensor configured to determine pressure at a first pressurized zone, and a controller configured to control an air pump at the first pressurized zone. The air pump is configured to regulate pressure at the first pressurized zone.

In another embodiment, a power wheelchair having an adaptable air loss cushion system is provided. The power wheelchair comprises a seat assembly support portion and at least one cushion in contract with the seat assembly portion, the at least one cushion having a first permeable surface and a plurality of pressurized zones. The wheelchair further comprises at least one sensor configured to determine pressure at the first pressurized zone and a controller configured to control an air pump at the first pressurized zone, wherein the air pump is configured to regulate pressure at the first pressurized zone.

In another embodiment, a method for regulating pressure in an adaptable air loss cushion is provided. The method includes receiving a first user input in the form of a target pressure at a first zone. The method further includes receiving a first pressure value from at least one sensor configured to determine pressure and activating a first air pump operably connected to the first zone according to the first user input target pressure. The method further comprises receiving a second pressure value from the at least one sensor after activation of the first air pump and terminating activation of the first air pump when the second pressure value is substantially the same as the input target pressure for the first zone.

These and other objects, features and advantages of the present invention will become apparent from the following detailed description of illustrative embodiments thereof, which is to be read in connection with the accompanying drawings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 shows an exemplary embodiment of a power wheelchair with an adaptable air loss cushion.

FIG. 2 shows an exemplary embodiment of an adaptable air loss cushion having a plurality of zones.

FIG. 3 is a cross-sectional view of an exemplary embodiment of an adaptable air loss cushion.

FIG. 4 is a schematic representation of an exemplary communication between an adaptable air loss cushion controller and a control device.

FIG. 5 is a schematic representation of exemplary control processing.

### DETAILED DESCRIPTION

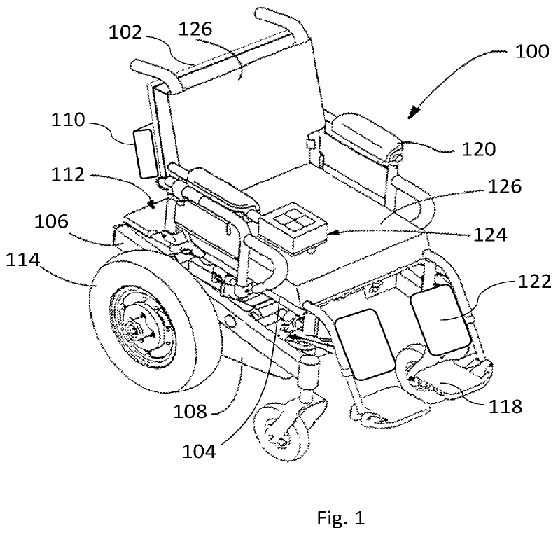

In FIG. 1, an exemplary embodiment of a wheelchair 100 is shown. Wheelchair 100 has a chair having a backrest frame 102 and a seat frame 104. A cushion 126 typically covers one or more support surfaces, such as, for example, the face of the backrest frame 102 and seat frame 104, or the user-facing surfaces of footrest 118, armrest 120, or legrest 122. The cushion 126 may comprise a single cushion piece adapted to cover the backrest frame 102 and seat frame 104, or may be comprised of a series cushion pieces connected by, for example, stitching or bonding. In some embodiments, the cushion 126 may be modular, i.e., made up of a series of independent cushions. In some embodiments, cushion 126 has at least a first permeable surface operable to allow continuous air loss or air flow to permeate through the permeable surface. Cushion 126 may have additional permeable surfaces that selectively allow air loss to permeate through the permeable surface. In some embodiments, cushion 126 has a plurality of pressurized zones and at least one air pump for regulating pressure in at least one zone. An air pump can regulate pressure or air loss at cushion 126 by activating or deactivating the pump at cushion 126. In certain embodiments, cushion 126 comprises at least one sealed zone. A pressure at a sealed zone may be increased or decreased by an air pump to vary the firmness or physical dimensions of cushion 126. It is appreciated that air loss as described herein may include air transfer through a permeable surface, or in the case of a sealed zone or cushion, through air added or removed in the cushion or zone by an air pump. In embodiments where cushion 126 has at least one permeable surface, varying pressures can cause an increase or decrease in the air loss at the permeable surface. By regulating air loss at a surface of cushion 126, a user can control factors such as temperature and humidity, improving comfort of the chair. Backrest frame 102 and seat frame 104 may be formed from a single piece (monolith) of material, such as, for example, sheet metal, metal, plastic and other materials. Alternatively, the backrest frame 102 and seat frame 104 can be formed of separate pieces and joined together. A cushion 126 may alleviate user discomfort and/or pressure at support surfaces 102, 104, 118, 120, and 122, as described below.

In some embodiments, a sidearm portion 120 is adjustably connected between backrest frame 102 and seat frame 104. Side arm portion 120 also braces these components together to control the adjustable angle between the components. In some embodiments, cushion 126 is configured to cover side arm portion 120. A cushion 126 covering side arm portion 120 may be part of a single continuous cushion also covering backrest frame 102 and seat frame 104, or may be a separate cushion 126 having independent pressurized zones. In some embodiments, a footrest 118 is provided forward of the seat frame 104 so as to provide a place for a user's legs. In some embodiments, footrest 118 is adjustable. In some embodiments, wheelchair 100 comprises a legrest 122 to support the calf muscle of a wheelchair operator. In yet another embodiment, footrest 118 and/or legrest 122 comprises a first and second portion for separate support of a left and right foot and/or leg of the wheelchair user. In other embodiments, footrest 118 is covered by a cushion such as cushion 126. In some embodiments, cushion 126 is associated with footrest 118 and/or legrest 122 and is operable to oscillate a pressure for promoting vascular pumping in lower limbs to combat fluid buildup.

In some embodiments, a control module 110 is affixed to the rear of backrest frame 102. Control module 110 can include an on/off switch and a port for connecting other electronic devices thereto such as, for example, a joystick controller, touchpad, switch controls, etc. In some embodiments Control Module 110 is configured to communicate with a wireless device which can be configured to transmit control signals to be received at the Control Module 110. It is contemplated that a wireless device such as, but not limited to, a cell phone, laptop computer, or tablet computer may be configured to communicate with Control Module 110 through an installed application on the wireless device. In some embodiments, a wireless device may be configured to communicate with Control Module 110 over Wi-Fi, Bluetooth, or similar communication protocols.

Though control module 110 is shown affixed to the back of backrest frame 102, it can be located on virtually any accessible portion of wheelchair 100. In some embodiments control module 110 includes a controller configured to control features related to cushion 126, such as, for example, pressure in one or a plurality of zones, air flow or air loss at one or a plurality of zones, background noise (e.g. a “quiet” mode), energy efficiency (e.g. a “green” mode), or cushion firmness or shape at one or a plurality of zones. In other embodiments, the controller is operable to alternate pressure for pressure relief, including changing pressure at a high frequency, adjusting the firmness or shape of the cushion to promote anatomical stability, adjust cushioning for dampening vibration and shocks while driving, temperature control through air circulation (heating and/or cooling), moisture or humidity control through air circulation, and oscillating pressure for promoting vascular pumping in lower limbs to combat fluid buildup.

In some embodiments, control module 110 also includes drive and control circuitry for sensing user input commands and generating drive signals for driving the motors of the wheelchair. In some embodiments, an optional headrest assembly may be adjustably attached to backrest frame 102. In some embodiments, a user input device 124, such as, for example, a joystick controller, touchpad, switch controls, etc., is adjustably attached to arms 120 for receiving drive inputs from the user. User input device 124 may further include controls operably connected to control module 110 for setting or adjusting features related to cushion 126. In some embodiments, user input device 124 has dedicated control hardware, such as, a processor and a memory. It is appreciated that in some embodiments, control module 110 may comprise one or more processors in communication with a memory. In some embodiments, control module 110 may comprise a plurality of controller devices in communication with one another.

Wheelchair 100 also has chassis 106 that accommodates a removable battery assembly 112 that reveals a battery compartment. In some embodiments, an additional battery is supplied for independent power output to cushion 126. Wheelchair 100 further includes drive wheels 114 and castor wheel 116. The other side of wheelchair 100 includes a similar drive wheel and a caster wheel. Each drive wheel is driven by an electric motor 108 or electric motor/gearbox combination so as to form a drive assembly. While the present embodiment is shown with the drive wheels substantially beneath seat 104, the drive wheels may be moved to different positions along chassis 106.

While FIG. 1 depicts a power wheelchair with an adaptable air loss cushion, it is appreciated that an exemplary air loss cushion may also be added to a standard manual wheelchair. In such embodiments, at least one air loss cushion is affixed to the self-propelled wheelchair by straps, ties, or the like, and connected to a discrete power source, such as a rechargeable battery.

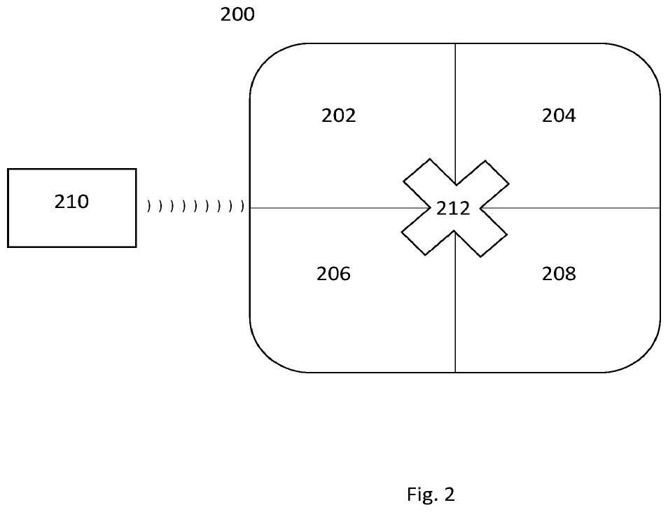

FIG. 2 shows an exemplary adaptable cushion 200 having pressurized zones, 202, 204, 206, and 208. It is appreciated that cushion 200 may have more or fewer pressurized zones than depicted in FIG. 2. In some embodiments, cushion 200 has at least one permeable surface operable to continuously release air out of the cushion, which can affect the pressure, temperature, an/or humidity at a surface of the cushion. In other embodiments, cushion 200 has at least one sealed zone, which when pressure is varied, may change the firmness or physical dimensions of cushion 200. Pressurized zones 202, 204, 206, and 208 are operably connected to air pump 212. In some embodiments, air pump 212 may be a small pump such as, for example, piezo, micro, diaphragm, etc. pumps. The micro-pumps used in some embodiments may be, for example, the type of pumps disclosed in U.S. Pat. No. 9,266,053, which is incorporated herein by reference, in its entirety.

Air pump 212 may be associated with one or more zones and in some embodiments, may be integrated into the cushion. Management and activation of several different configurations of micro-pumps may be optimized for energy efficiency. In some embodiments, a user may select settings optimized for energy efficiency, for example, a “green” mode. It is also appreciated that an energy efficiency mode could be selected to preserve battery power to the chair when the user is running low on battery power and not near a charging source. In some embodiments, certain pump configurations may be used to intentionally limit power consumption of the cushion 200. In other embodiments, a single zone may have a plurality of pumps that may be separately controlled. For example, a zone may have a primary and secondary pump, each having different power consumption, enabling more control over power consumption.

In another embodiment, a conventional pump(s), including, for example, rotary, screw, vane, scroll, piston, wobble, or any other positive pressure device suitable for use on a wheelchair may be centralized and used for multiple cushions with a manifold. Air pump 212 may also be used to remove pressure from the cushion, for example, when the air loss rate through a permeable surface is not sufficient to achieve the desired pressure reduction. In one embodiment, pressure removed from one cushion or zone may be used to pressurize another cushion or zone. In some embodiments, air pump 212 is a single pump, in other embodiments air pump 212 is a series of connected smaller pumps, for example, micro-pumps.

The pressurized zones 202, 204, 206, and 208 may be operably connected to controller 210 and air pump 212. In some embodiments, controller 210 communicates with air pump 212 over a wireless connection, for example, Bluetooth, Near Field Communication (NFC), Wi-Fi, or the like. In some embodiments, controller 210 is operably connected with air pump 212 over a wired connection. Controller 210 is configured to accept an input and transmit that input to the air pump 212 and cause the air pump to activate. In some embodiments, controller 210 receives an input via user input via an optional user interface. Controller 210 may also receive an input through an upload or download of instructions, such as, for example a therapeutic schedule or routine, which controller 210 is configured to implement. Controller 210 may be configured to control air pump 212 in accordance with therapeutic schedules or routines, as described in more detail below. In some embodiments air pump 212 is a single pump operable to deliver different pressures to a zone, independently. In some embodiments, air pump 212 comprises multiple pumps and or sub-pumps in connection with each other. In some embodiments, controller 210 may be configured to accept and process user input from a physical controller. In some embodiments controller 210 is configured to accept and process user input over a wireless connection to a cellular phone, tablet computer, or the like. Air pump 212 may be configured to independently control pressure at a zone based on user input. For example, if a user wants to increase the pressure in zone 202 and decrease the pressure in zone 208, air pump 212 is operable to independently operate to regulate the pressures in those zones.

In some embodiments air pump 212 is configured to determine the pressure at zones 202, 204, 206, and 208. In another embodiment, at least one sensor is used to determine pressure, temperature, and/or humidity at each zone. In some embodiments, the pressure, temperature, and/or humidity at each zone is aggregated to determine a value for the entire cushion or support surface.

It is another aspect of the present disclosure that pressurized zones 202, 204, 206, and 208 may be utilized to physically alter the dimensions and size of the zones, or cushion 200. As greater pressure is applied, it is possible to affect the cushion's firmness at the pressurized zone. As more pressure applied, the more firm the zone will become. As pressure is removed from the zone, the zone will become softer. In some embodiments, the shape or sculpting of the zones may be changed in order to facilitate anatomical stability of the wheelchair user, or alter the physical dimensions of cushion 200. In some embodiments, zones may have pressure applied to sculpt the cushion to facilitate a user's exit from the chair, for example, increasing pressure in the rear zones while decreasing pressure in the forward zones, creating a wedge to partially lift the user out of the chair. In some embodiments, air pump 212 may be configured differently for a sealed zone or a permeable air loss zone in order to consistently adjust firmness or the shape of cushion 200.

It is appreciated that in some embodiments, a series of cushions 200 may be modularly connected to one another. For example, a seat cushion may be connected with a first and second armrest cushion, a first and second legrest cushion, a backrest cushion, and a head rest cushion. In some embodiments, a modular series of connected cushions may be controlled by a single controller 210, in substantially the same way a single cushion is controlled.

In some embodiments cushion 200 may be used for applications outside of wheelchairs. For example, cushion 200 may be formed as a pillow, mattress, or other support surface. It is further contemplated that cushion 200 be utilized in other seating configurations such as, for example, an office chair, an automobile seat, or the like.

It is a further aspect of air pump 212 that acoustic noise generated is kept to a minimum. In some embodiments, a dampening material may be added to cushion 200 to limit noise generated by air pump 212. In some embodiments the dampening material is used inside cushion 200. In other embodiments, the dampening material is used to cover cushion 200. In other embodiments, the dampening material may be used to cover air pump 212. It is a further aspect of cushion 200 that a user may vary speed or activation of air pump 212 based at least on a sound setting. For example, a user may select a “quiet” mode that would reduce activity of air pump 212 to account for the sound produced. It is appreciated that in certain embodiments, certain types or configurations of air pumps may not generate any sound at all, i.e., piezoelectric pumps may be inherently silent to the human ear.

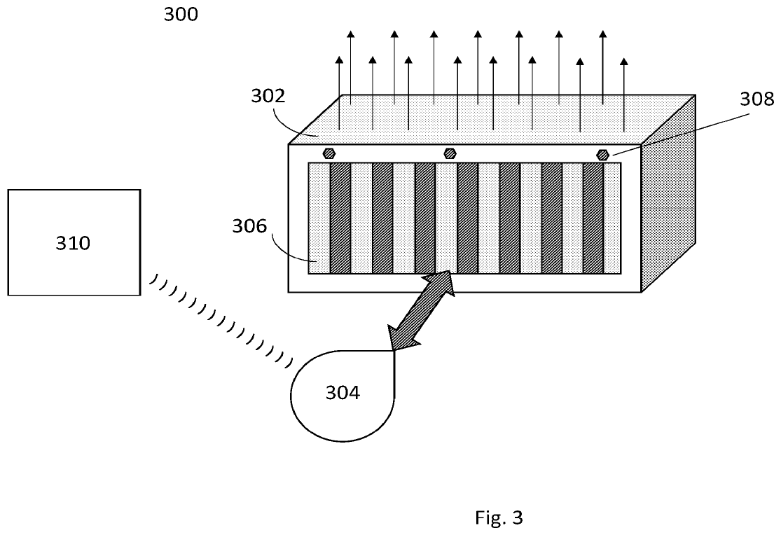

FIG. 3 is a cross-sectional view of an exemplary embodiment of an adaptable air loss cushion 300. Cushion 300 has at least a first permeable air loss layer 302, which is configured to allow for continuous air loss out of cushion 300. It is a further appreciated that cushion 300 may have more than one permeable air loss layer. In some embodiments, air loss layer 302 may have a plurality of apertures, holes, openings, gaps, etc., of various sizes and distribution about air loss layer 302. It will be appreciated that while described as “holes” or “openings” herein, the air loss layer may have additional opening types that allow for air loss or air flow through the permeable surface. In other embodiments, the holes of air loss layer 302 are of equal size and uniformly distributed throughout air loss layer 302. In some embodiments, the first permeable air loss layer 302 may have different configurations of openings distributed about air loss layer 302, or at different support surfaces. For example, an air loss layer located on a seat cushion may have larger openings to allow for more air loss to compensate for greater user contact area with the support surface, while an air loss layer located on an armrest might have smaller openings to limit air loss where it is more likely a user's skin is contacting the support surface. In certain embodiments, heating may be achieved at air loss layer 302 by heating the air with a heater, for example, in one embodiment, through a resistive filament. In some embodiments, air loss layer 302 has a plurality of zones. It is appreciated that a zone may be defined by the amount of air loss, type of openings, number of openings, support surface type, type of material, type of covering, etc. In some embodiments, the air loss layer is covered in additional fabric material for added comfort for a user or to dampen sound generated by air pump 304.

A series of sealed side walls 306 form the pressurized zone of cushion 300. In some embodiments, a pair of side wall forms a sealed cavity, operably connected to an air pump 304. In some embodiments, a sealed cavity is controlled by a dedicated micro-pump. In some embodiments side walls 306 are permeable or semi-permeable to allow air flow through the side walls.

It is appreciated that cushion 300 is depicted as having a single zone, however, a cushion having a plurality of pressurized zones would function in a substantially similar way. Air pump 304 is configured to receive user input from controller 310. Sensors 308 are configured to determine pressure, temperature, and/or humidity at the air loss layer 302 and transmit pressure, temperature, and/or humidity data to controller 310. In some embodiments, sensors 308 are configured to determine pressure, temperature, and/or humidity, inside cushion 300. In other embodiments, sensors 308 are configured to determine how long a pressure point has been active (i.e. if a user has been sitting in one position for too long and prone to develop a sore). In some embodiments, sensors 308 may be operably connected to a notification device. A notification device is configured to alert or notify a user of measured activity above or below a certain threshold. For example, if a user has been sitting long enough to potentially cause a sore, the notification device could alert the user to move. A notification could be sent in the form of a vibration, a sound, a light, a message to a user's smart phone or computer, etc. It is appreciated that sensors 308 may determine values independently for each zone, or may aggregate data to determine values for an entire cushion.

It is appreciated that in certain embodiments, cushion 300 may have at least one zone with no permeable air loss layers, i.e. sealed. A sealed zone of cushion 300 may have an air pump 304, side walls 306, and sensors 308, and experience no measurable air loss. A plurality of sealed zones may be configured in cushion 300 so that the cushion does not have any permeable air loss layers.

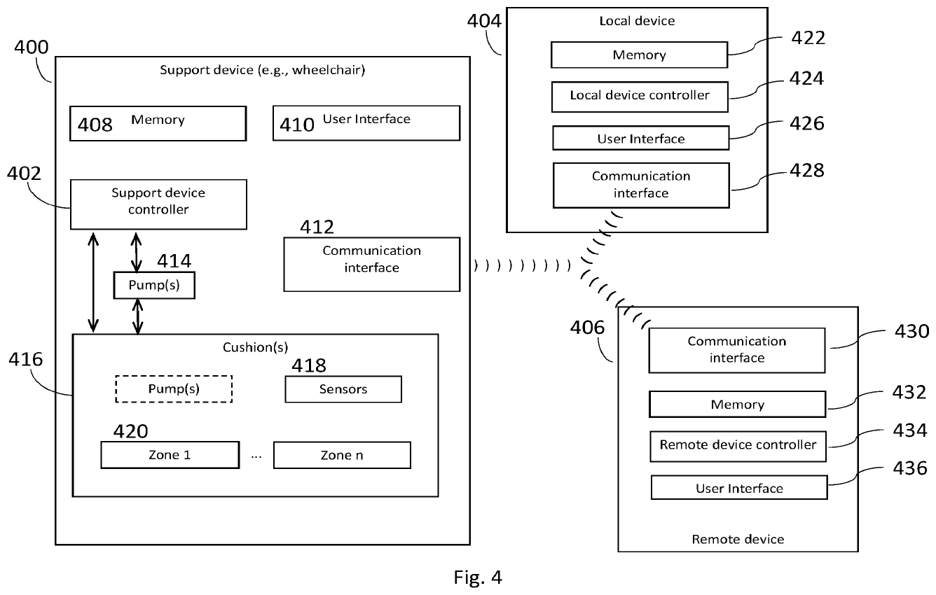

FIG. 4 shows a block diagram depicting an exemplary communication between a support device 400 having at least support device controller 402 and a control device such as a local device 404 and/or a remote device 406. In another embodiment, settings may be provided and/or adjusted by a local device 404 in communication with the support device 400. For example, a user's smart phone may be in communication with the wheelchair via a bluetooth connection to exchange settings, routines, etc. In another embodiment, settings may be provided and/or adjusted by a remote device 406 in communication with the support device directly or via a local device 404. For example, a user's smart phone may be in communication with the remote device via a data connection, including, for example, cellular, Wi-Fi, and/or various internet connection methods. The remote device 406 and local device 404 may also communicate directly. Data may also be transferred from the support device 400 to a local device 404 and/or remote device 406 for various purposes, including, for example, monitoring programs, analysis, compliance, prescription, etc. In one embodiment, for example, a remote therapist can review data received from the wheelchair and provide a new therapy schedule to be uploaded to the wheelchair. In another embodiment, data may be transferred to an external data center to monitor and record user behavior and adjust therapy regimes based on that behavior. It is appreciated that support device 400, local device 404, and remote device 406 are all operable to communicate with one another via their respective communication interfaces, 412, 428, and 430. The communication interfaces 412, 428, and 430 may include various devices suitable for any type of communication, including, for example, network connections (e.g., modem, LAN, WAN), wired (e.g., USB, Ethernet), wireless interfaces (as mentioned above), portable storage medium interfaces (e.g., flash drive ports (e.g., memory sticks, USB, multimedia, SD, compact flash)), etc., including for communication with remote devices and/or stations.

Support device 400 has at least a support device controller 402 in communication with a memory 408. Memory 408 may be of any type or configuration, including, for example, local, remote, permanent, removable, centralized, shared, etc. The memory 408 may also store a database of pressure management routines, therapeutic schedules, plans, regimens, regimes, etc.

In some embodiments, support device 400 has a user interface 410 configured to receive and transmit user input and/or control signals to support device controller 402. In some embodiments, user interface 410 comprises a digital display, such as, for example, an LCD, LED, OLED, or the like. User interface 410 may include various input devices, such as, for example, buttons, dials, mouse, keyboard, touch-pad, etc. A display may further include one or more displays, including, for example, monitors, readouts, LCDs, LEDs, etc.

Support device controller 402 is configured to receive input from user interface 410 and/or from local device 404 and remote device 406. Support device controller 402 is further configured to activate pumps 414 based on a user input. In some embodiments, pumps 414 are associated with a cushion(s) 416. Cushions 416 may have sensors 418 for determining or capturing data, for example, pressure, temperature, and humidity data related to the support device 400 or cushion(s) 416 and transmitting the determined data to support device controller 402 or memory 408. In some embodiments, sensors 418 are configured to transmit data for display on user interface 410. In some embodiments, sensors 418 may transmit data to local device 404 and/or remote device 406. Cushion(s) 416 may also have a plurality of pressurized zones 420 operably connected to pumps 414.

Local device 404 has at least a memory 422, a local device controller 424, a user interface 426, and a communication interface 428. Remote device 406 has at least a memory 432, a remote device controller 434, a user interface 436, and a communication interface 430.

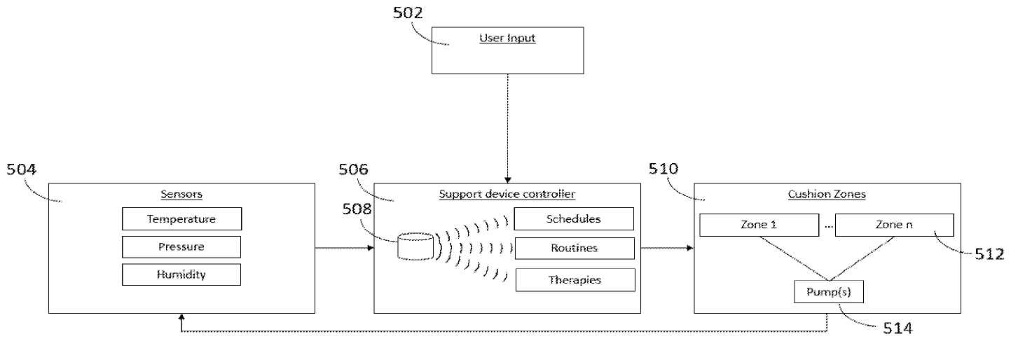

FIG. 5 is a schematic representation of exemplary control processing. Support device controller 506 may be configured to receive inputs as data or control signals and implement various therapeutic functions at cushion zones 510. In some embodiments, support device controller 506 receives data input from sensors 504 and/or user input 502. Sensors 504 may comprise sensors configured to measure or detect data related to temperature, pressure, humidity, movement, light, etc. In some embodiments, a single sensor may be configured to measure or detect multiple properties. Data from sensors 504 may be stored in memory or transmitted to a third party, such as a therapist or physician. In some embodiments, data from sensors 504 is transmitted to support device controller 506. Support device controller 506 may have a processor and a memory configured to interpret or process data from user input 502 and/or sensors 504 into schedules, routines, or therapies to be stored in a memory 508. In some embodiments, schedules, routines, or therapies are pre-determined by a physician or therapist to facilitate care for a user, and uploaded to support device controller 506 for storage in memory 508. The therapies, schedules, or routines can include predetermined or designed variations in pressures, air flow, etc, for various zones in order to facilitate therapeutic relief. In some embodiments, the therapies, schedules, or routines are generated without user input. In other embodiments, support device controller 506 may generate new therapies, schedules, or routines based on observed or recorded user behavior. In some embodiments, observed or recorded user behavior may be used in conjunction with artificial intelligence or machine learning to modify, adjust, or create new therapy regimes based on the observed user behavior.

In other embodiments, therapies are adaptable, meaning they are operable to be modified based on received data from sensors 504. For example, if a prescribed user therapy suggests that a user reduce or eliminate pressure points with respect to a certain support surface, the therapy may be modified based on temperature or pressure data from the relevant support surface. Some examples of schedules, routines, and therapies are alternating pressure for pressure relief, including embodiments changing pressure at a high frequency, changing pressures according to a pre-set time or schedule, adjustable positioning for anatomical stability, adjustable cushioning for dampening vibration and shocks while driving, temperature control through air circulation, cooling, and/or heating, moisture control through air circulation, or oscillating pressure for promoting vascular pumping in lower limbs to combat fluid buildup. These and other therapies are merely examples and are not limiting. Other possible therapies will be appreciated by those of skill in the art.

In some embodiments support device controller 506 interprets the schedules, routines, and/or therapies into control signals to be transmitted to cushion zones 510. Cushion zones 510 include a least zone(s) 512 and pump(s) 514. Cushion zones 510 are configured to receive and interpret the control signals generated by support device controller 506, which activate/deactivates pumps 514 in zones 512. In some embodiments, a prescribed therapy may require feedback to confirm that the therapy has been completed or modify therapy program based on feedback. As a therapy is implemented at cushion zones 510, feedback data is generated and transmitted to sensors 504. Sensors 504 are configured to receive the feedback data and generate contextual data, such as change in temperature over time, etc., and transmit that data to support device controller 506. In some embodiments feedback data is transmitted directly to support device controller 506. In some embodiments, support device controller 506 is configured to implement logic, for example, some embodiments include artificial intelligence or machine learning, operable to override, adjust, or modify schedules, routines, or therapy based on received feedback from sensors 504. For example, if a therapy is currently being performed, but a temperature sensor detects an elevated temperature at a support surface, support device controller logic may modify the current therapy to increase air loss at the zone experiencing the elevated temperature in order to reduce temperature. In some embodiments, when modification of a therapy has been performed a notification is generated and transmitted to a user, therapist, or physician. In some embodiments, the notification is stored in a memory for access the next time the wheelchair is serviced.

A user may generate a user input 502 by interacting with a user input device such as, for example, a touchpad, joystick controller, keypad, knobs, switch controls, etc.to generate control signals. In some embodiments, user input 502 does not require user intervention, or in other words, comprises pre-configured instructions or routines. User input 502 transmits control signals to the support device controller 506 and may be used to override, adjust, or modify the schedules, routines, or therapies as implemented by support device controller 506. The ability to override, adjust, or modify may be adjusted depending on a user or the prescribed therapy.

“Circuit” or “circuitry,” as used herein includes, but is not limited to, hardware, firmware, software or combinations of each to perform a function(s) or an action(s). For example, based on a desired feature or need, a circuit may include a software controlled microprocessor, discrete logic such as an application specific integrated circuit (ASIC), or other programmed logic device. A circuit may also be fully embodied as software. As used herein, “circuit” is considered synonymous with “logic.”

“Controller,” as used herein includes, but is not limited to, any circuit or device that coordinates and controls the operation of one or more input or output devices. For example, a controller can include a device having one or more processors, microprocessors, or central processing units (CPUs) capable of being programmed to perform input or output functions.

“Logic,” as used herein includes, but is not limited to, hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), or other programmed logic device. Logic may also be fully embodied as software. As used herein, “logic” is considered synonymous with “circuit.”

“Operative communication” or “circuit communication,” as used herein includes, but is not limited to, a communicative relationship between devices, logic, or circuits, including mechanical and pneumatic relationships. Direct electrical, electromagnetic, and optical connections and indirect electrical, electromagnetic, and optical connections are examples of such communications. Linkages, gears, chains, push rods, cams, keys, attaching hardware, and other components facilitating mechanical connections are also examples of such communications. Pneumatic devices and interconnecting pneumatic tubing may also contribute to operative communications. Two devices are in operative communication if an action from one causes an effect in the other, regardless of whether the action is modified by some other device. For example, two devices separated by one or more of the following: i) amplifiers, ii) filters, iii) transformers, iv) optical isolators, v) digital or analog buffers, vi) analog integrators, vii) other electronic circuitry, viii) fiber optic transceivers, ix) Bluetooth communications links, x) 802.11 and 802.15 communications links, xi) satellite communication links, xii) near-field communication, and xiii) other wireless communication links. As another example, an electromagnetic sensor is in operative communication with a signal if it receives electromagnetic radiation from the signal. As a final example, two devices not directly connected to each other, but both capable of interfacing with a third device, e.g., a central processing unit (CPU), are in operative communication.

“Signal,” as used herein includes, but is not limited to, one or more electrical signals, including analog or digital signals, one or more computer instructions, a bit or bit stream, or the like.

“Processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

“Software,” as used herein includes, but is not limited to, one or more computer readable or executable instructions that cause a computer or other electronic device to perform functions, actions, or behave in a desired manner. The instructions may be embodied in various forms such as applications (apps), routines, algorithms, modules or programs including separate applications or code from dynamically linked libraries. Software may also be implemented in various forms such as a stand-alone program, a function call, a servlet, an applet, instructions stored in a memory, part of an operating system, or other types of executable instructions. It will be appreciated by one of ordinary skill in the art that the form of software is dependent on, for example, requirements of a desired application, the environment it runs on, or the desires of a designer/programmer or the like.

While the above exemplary definitions have been provided, it is Applicant's intention that the broadest reasonable interpretation consistent with this specification be used for these and other terms.

It is to be understood that the detailed description is intended to be illustrative, and not limiting to the embodiments described. Other embodiments will be apparent to those of skill in the art upon reading and understanding the above description. Moreover, in some instances, elements described with one embodiment may be readily adapted for use with other embodiments. Therefore, the methods and systems described herein are not limited to the specific details, the representative embodiments, or the illustrative examples shown and described. Accordingly, departures may be made from such details without departing from the spirit or scope of the general aspects of the present disclosure.

What is claimed is:

1. An adaptable cushion system comprising:
at least one cushion having a plurality of pressurized zones;
at least one sensor configured to determine pressure at a first pressurized zone;
a controller configured to control an air pump associated with the first pressurized zone, the air pump configured to regulate pressure of the first pressurized zone.

2. The adaptable cushion system of claim 1, wherein the controller is further configured to regulate air flow through a first permeable surface of the at least one cushion.

3. The adaptable cushion system of claim 1, wherein the at least one sensor is further configured to determine a temperature or a humidity at a first surface of the at least one cushion.

4. The adaptable cushion system of claim 1, wherein at least a first and a second pressurized zone have a shared permeable side wall to allow air flow between the first and second pressurized zones.

5. The adaptable cushion system of claim 1, further comprising a user interface configured to communicate with the controller and activate the air pump at the at least one pressurized zone.

6. The adaptable cushion system of claim 5, wherein the controller is further configured to regulate air flow at the first pressurized zone according to a user input at the user interface.

7. The adaptable cushion system of claim 6, wherein the user input is at least one of a target temperature, a target pressure, a target humidity, or a target firmness.

8. The adaptable cushion system of claim 1, wherein the controller is further configured to control an air pump associated with a first and a second zone.

9. The adaptable cushion system of claim 8, wherein the controller is further configured to control an air pump associated with the first zone independently from control of an air pump associated with the second zone.

10. The adaptable cushion system of claim 1, wherein the controller is further configured to control the air pump to reduce sound made by the air pump.

11. A power wheelchair having an adaptable cushion system, the power wheelchair comprising:
a seat assembly support portion;
at least one cushion in contract with the seat assembly support portion, the at least one cushion having a plurality of pressurized zones;
at least one sensor configured to determine pressure at a first pressurized zone;
a controller configured to control an air pump associated with the first pressurized zone, the air pump configured to regulate pressure at the first pressurized zone.

12. The power wheelchair of claim 11, wherein the wheelchair has a first and second side portions and the at least one cushion is in contract with the first and second side portions and the seat assembly portion.

13. The power wheelchair of claim 11, wherein the controller is further configured to regulate air flow at a first permeable surface of the at least one cushion.

14. The power wheelchair of claim 11, wherein the at least one sensor is configured to determine a temperature and a humidity at the first permeable surface.

15. The power wheelchair of claim 11, wherein the controller is further configured to control an air pump associated with a first and a second pressurized zone.

16. A method for regulating pressure in an adaptable air loss cushion, the method comprising:
receiving a first input in the form of a target pressure at a first zone of the adaptable air loss cushion;
receiving a first pressure value at the first zone from at least one sensor configured to determine pressure;
activating a first air pump operably connected to the first zone according to the first input target pressure;
receiving a second pressure value at the first zone from the at least one sensor after activation of the first air pump;
terminating activation of the first air pump when the second pressure value at the first zone is substantially the same as the input target pressure for the first zone.

17. The method of claim 16, further comprising:
receiving a second input in the form of a target pressure for a second zone of the adaptable air loss cushion;
receiving a first pressure value at the second zone from at least one sensor configured to determine pressure;
activating a second air pump operably connected to the second zone of the air loss cushion according to the second input target pressure;
receiving a second pressure value at the second zone from the at least one sensor after activation of the second air pump;
terminating activation of the first air pump when the second pressure value at the second zone is substantially the same as the input target pressure for the second zone.

18. The method of claim 16, further comprising:
activating at least the first air pump according to a pre-determined therapy routine that defines the target pressure input.

19. The method of claim 18, further comprising:
receiving feedback information from the at least one sensor during the pre-determined therapy routine;
modifying pre-determined therapy routine based on the received feedback.

20. The method of claim 18, further comprising:
receiving a temperature value at the first zone from at least one sensor configured to determine temperature at the first zone;
receiving a temperature value at the second zone from at least one sensor configured to determine temperature at the first zone;
activating at least one of the first or second pumps until the temperature value at the first zone is substantially the same as the temperature value at the second zone.
